(19) United States
(12) Patent Application Publication
(10) Pub. No.: US 2012/0192428 A1
(43) Pub. Date: Aug. 2, 2012

(54) Electric Shaver With Moisturizing Bar

(75) Inventors: Gary Lee McMurray, Verona, WI (US); Daniele Rosati, Verona, WI (US); Frank Mercurio, Madison, WI (US); James Raymond Patullo, Middleton, WI (US); David W. Everett, Verona, WI (US); Richard A. Harthun, Eagle, WI (US)

(73) Assignee: ROVCAL, INC., Madison, WI (US)

(21) Appl. No.: 13/017,852

(22) Filed: Jan. 31, 2011

(51) Int. Cl. B26B 19/48; A61Q 9/02; B26B 19/38

(52) U.S. Cl. 30/41; 30/537; 132/200

(57) ABSTRACT

A shaver includes a body, a shaver head including at least one shaving surface, and at least one electrically powered blade in the body adjacent the shaver head. The shaver also includes a receiver assembly connected to the body adjacent the head and a solid lubricant bar removably mounted in the receiver. The bar is mounted for removal from the shaver.

### FIELD

The present disclosure relates generally to electric shavers, and more particularly to an electric shaver with a replaceable moisturizing bar mounted thereon.

### BACKGROUND

Conventional electric shavers can cause redness and irritation during shaving. Numerous attempts have been made to solve this problem, including using wet shaving techniques. In wet shaving techniques, a lathering moisturizer is typically applied to the skin. This lathering moisturizer may be contained in a reservoir mounted on the shaver for dispensing directly onto the skin from the shaver itself. The shaver may be designed to dispense the liquid moisturizer during shaving. However, such systems do not consistently and evenly dispense the liquid moisturizer. Moreover, the liquid moisturizer is typically difficult to refill or replace.

Accordingly, an improved system for providing a lathering moisturizer in a wet/dry electric shaver system is needed.

### BRIEF SUMMARY

In one aspect of the disclosure, a shaver comprises a body, a shaver head including at least one shaving surface, and at least one electrically powered blade in the body adjacent the shaver head. The shaver also comprises a receiver assembly connected to the body adjacent the head and a solid lubricant bar removably mounted in the receiver. The bar is mounted for removal from the shaver.

In another aspect, a moisturizer bar assembly is adapted for connection to an electric shaver. The moisturizer bar assembly comprises a moisturizer bar adapted to deliver the moisturizer therein upon contact with skin, and a connector for connecting the moisturizer bar to the electric shaver.

In still another aspect, a method of shaving and simultaneously moisturizing the skin comprises providing an electric shaver having a built-in solid moisturizer bar adjacent a shaver head of the electric shaver. The method further comprises activating the shaver and contacting the skin with the shaver head of the electric shaver while simultaneously contacting the skin with the moisturizer bar.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a perspective view of one embodiment of the electric shaver with moisturizing bar and receiver assemblies.

FIG. 2 is a top perspective view of the assemblies.

FIG. 3 is a bottom perspective view of the assemblies.

FIG. 4 is a top perspective view of the assemblies with a portion removed for clarity.

FIGS. 5 and 6 are exploded views of the assemblies.

FIG. 7 is a cross-section perspective view of the assemblies.

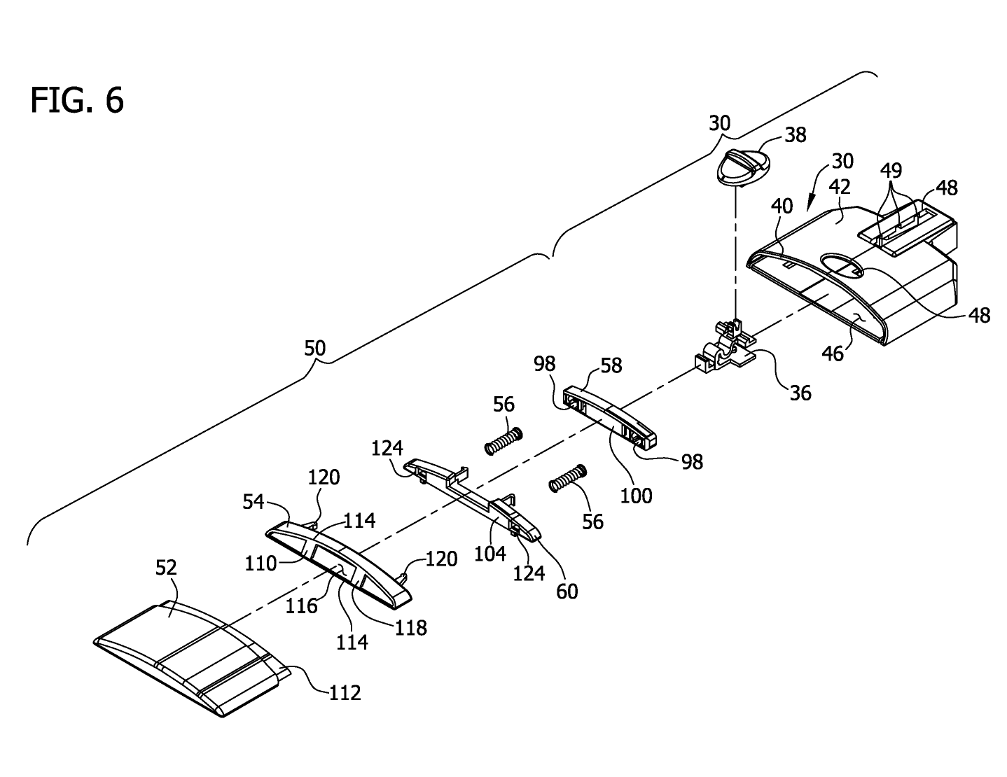

FIG. 8 is a perspective view of a slide.

FIG. 9 is a perspective view of a button.

FIG. 10 is a top perspective of the assemblies similar to FIG. 2 but with a button and moisturizing bar slid forward relative to a housing.

### DETAILED DESCRIPTION

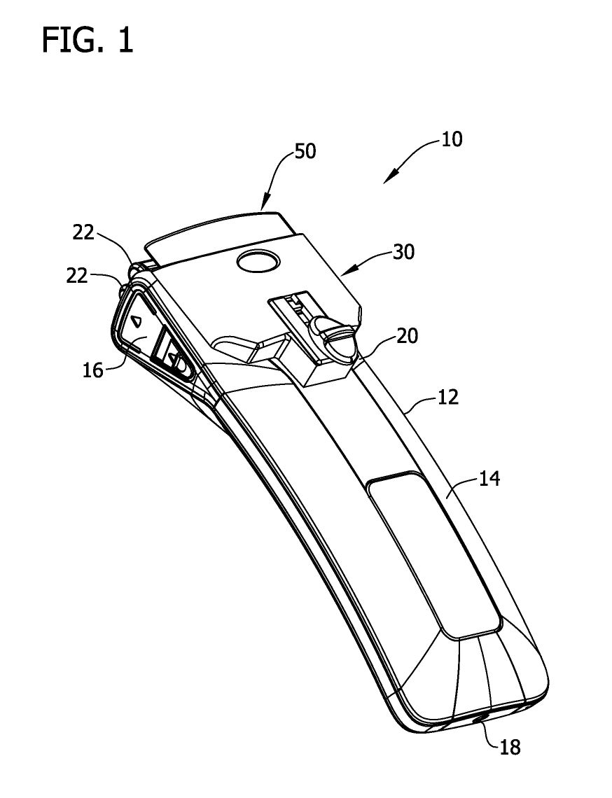

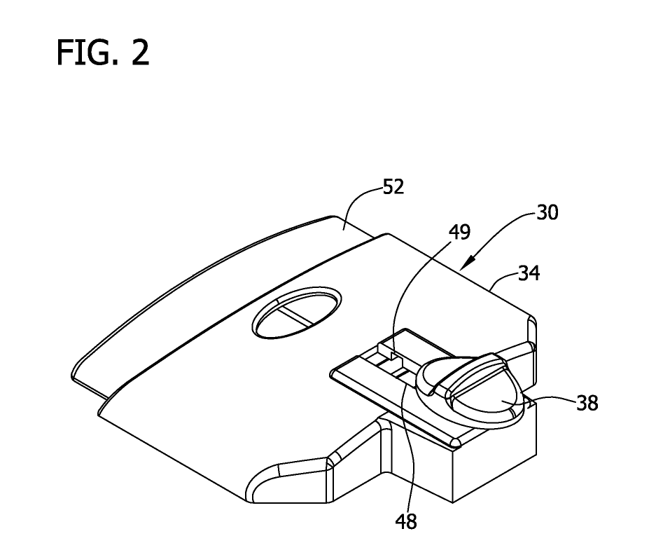

Referring now to the drawings, and in particular to FIGS. 1 and 2, an electric shaver according to one embodiment is indicated generally by the reference number 10. This shaver 10 is a foil shaver designed for trimming or shaving facial hair (e.g. a moustache or beard). However, other types and models of shavers and trimmers are contemplated within the scope of this disclosure. For example, the shaver 10 may also be of the type designed for shaving body hair.

In the illustrated embodiment, the shaver 10 comprises a body, generally indicated at 12, including a handle portion 14, and a shaver head, generally indicated at 16 that may be releasably connected to the body. While not illustrated in the drawings, the body 12 houses a suitable rechargeable battery, a motor, and associated electronics (e.g., circuitry), all of which are known to those skilled in the art for operating the trimmer. An electrical socket 18 for charging the battery is accessible by a user on an exterior of the body 12. A user interface (e.g., a power switch, not shown) for operating the shaver 10, and an upper section 20 at which the shaver head 16 removably connects to the body 12. In this embodiment, the head 16 includes two foil shavers 22. Such foil shavers 22, which include at least one electrically powered blade, are known to those skilled in the art and will not be further described. Rotary or other types of shaving heads 16 are also contemplated within the scope of this disclosure.

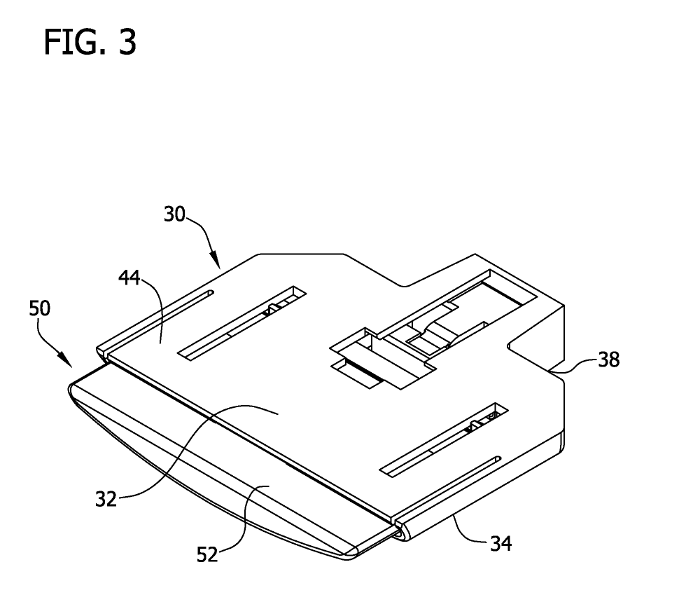

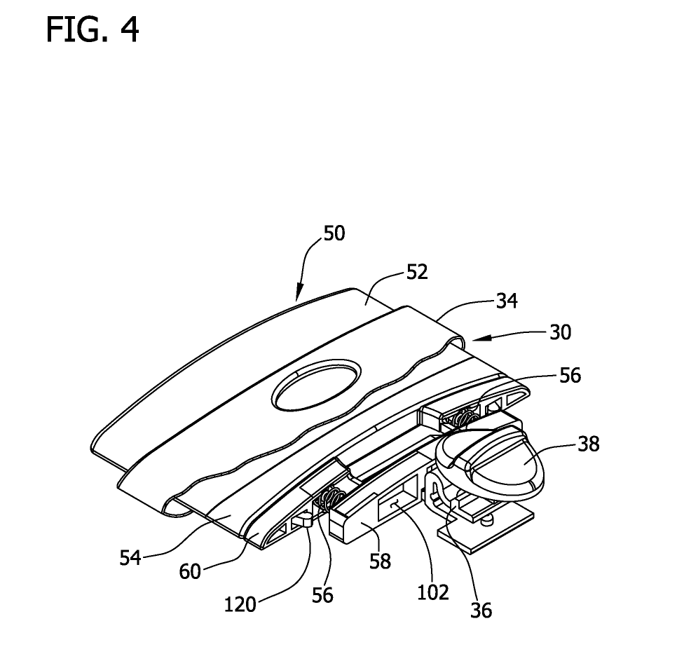

Turning to FIGS. 2-6, a receiver assembly is generally designated 30 and a moisturizing bar assembly is generally designated 50. The receiver assembly 30 is connected by suitable means to the shaver 10, and the moisturizing bar assembly 50 is connected to the receiver assembly by suitable means. In this embodiment, a back side 32 of the receiver assembly 30 (FIG. 3) is fixed to the shaver body 12 adjacent the shaver head 16. The receiver assembly 30 may be attached to the shaver 10 so as to be removable or non-removable (permanently affixed). In one embodiment, the receiver assembly 30 is secured to the shaver 10 by an adhesive, while in other embodiments, the receiver assembly is secured by mechanical means such as by fasteners. The receiver assembly 30 is disposed such that when the moisturizing bar assembly 50 is received therein, a moisturizing bar 52 (broadly, a solid lubricant bar) is disposed so as to contact the skin of the user adjacent to the area being shaved.

As shown in FIGS. 2-5, the receiver assembly 30 of this embodiment includes a housing 34, a slide 36 and a button 38. The moisturizing bar assembly includes the moisturizing bar 52, a bar holder 54 (broadly, a connector), two springs 56 and first and second spring plates 58, 60.

The housing 34 of this embodiment generally includes an open end 40, and upper and lower faces 42, 44. The housing 34 includes a long, narrow void 46 extending inward from the open end 40 for receiving the slide 36 and moisturizing bar assembly 50. The housing also includes a slot 48 in the upper face 42 for receiving the slide 36 and button 38. This slot 48 has several cut-outs 49 that define stops for the slide 36 and button 38, as will be further described.

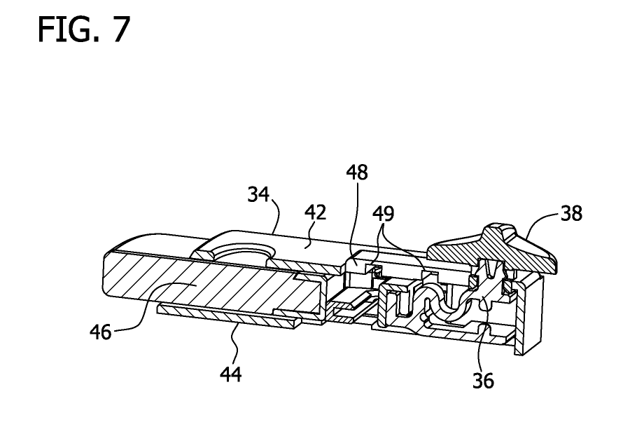

The slide 36 is also received in the housing 34. As shown in FIG. 8, the slide 36 of this embodiment includes upper and lower flanges 62, 64 defining a space 66 therebetween. The upper flange 62 includes tangs 68 with small hooks 70 thereon for insertion into and engagement with the button 38. The upper flange includes an “S” curve section 72 to enable the upper flange 62 to be pushed or forced downward in use and spring back resiliently when the force is removed. The inner surfaces 74, 76 of the upper and lower flanges 62, 64 include opposed bosses 78 thereon to limit the downward movement of the upper flange 62. A catch 80 extends from a forward surface 82 of the slide for engagement with the first spring plate 58.

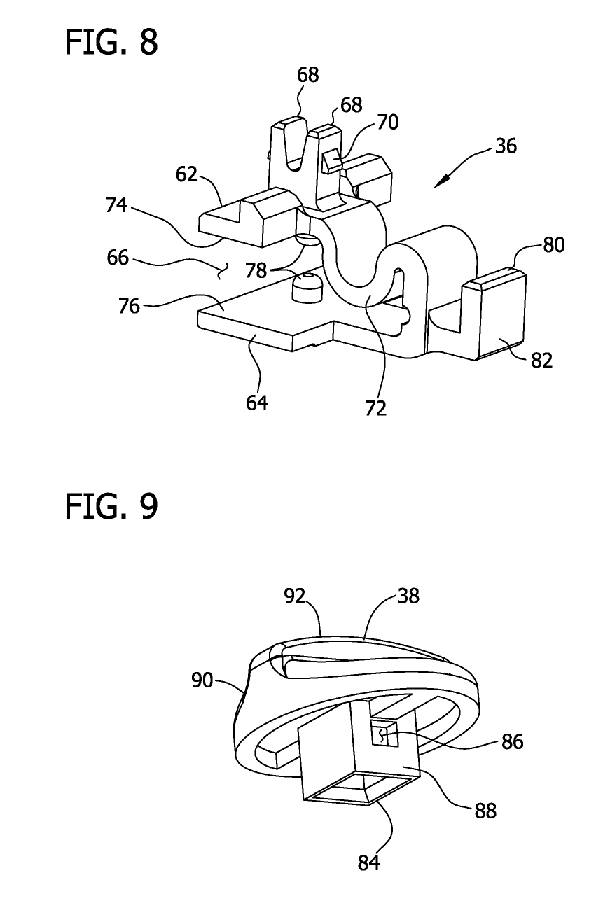

The button 38 (FIG. 9) includes a receptacle 84 for receiving the tangs 68 of the slide 36. The hooks 70 of the slide 36 are received in small holes 86 in sidewalls 88 of the receptacle 84. An upper portion 90 of the button 38 has a ridge 92 that facilitates a user sliding the button and slide 36 along the slot 48 in the housing 34 after pressing the button inward to release the button from one of the cut-outs 49 in the slot of the housing.

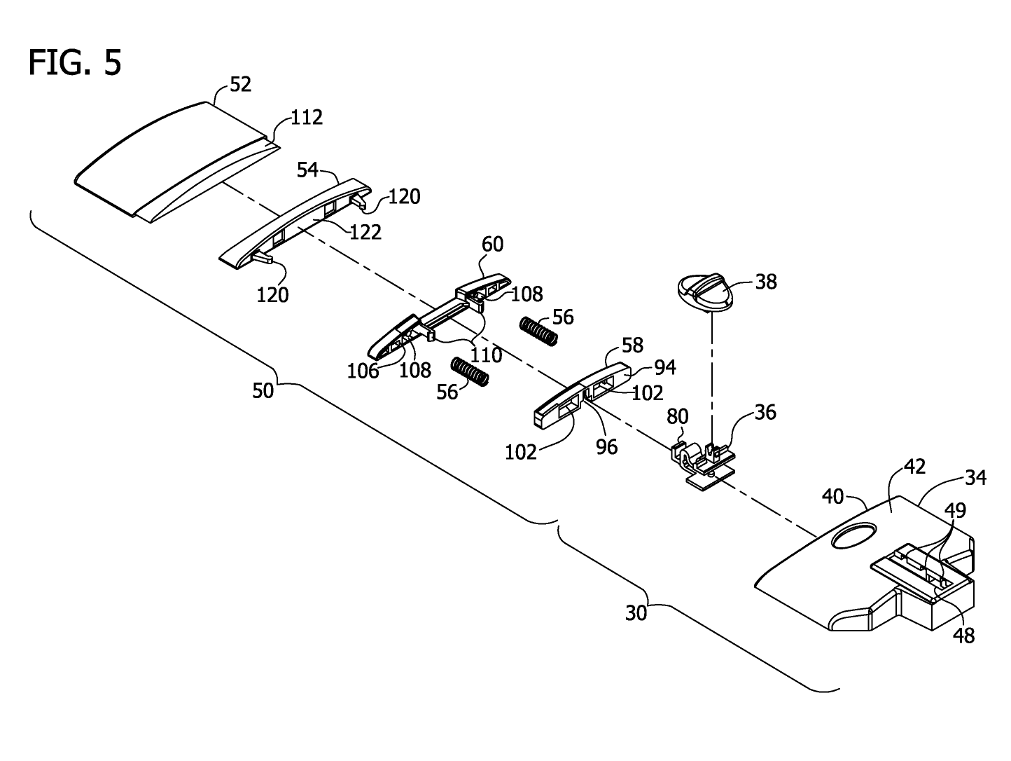

In this embodiment, the first spring plate 58 (FIGS. 5 and 6) is elongate and has a groove 96 in a rearward surface 94 for receiving the catch 80 of the slide 36. The first spring plate 58 has openings 98 in a forward surface 100 for receiving the springs 56. The first spring plate 58 also has through holes 102 for receiving portions of the second spring plate.

The two springs 56 of this embodiment are coil compression springs. Ends of each spring 56 are seated in the openings 98 of the first and second spring plates 58, 60, respectively. The springs 56 are adapted to facilitate movement of the bar 52 along at least one axis, in some embodiments along at least two axes, and in some embodiments along at least three axes. In this way, the moisturizing bar can be maintained in contact with the skin while shaving. In other words, most of the surface of the moisturizing bar will be in contact with the skin while shaving due to the springs. Note that other mechanisms for providing the multi-axis motion of the bar are contemplated within the scope of this disclosure.

In this embodiment, the second spring plate 60 is elongate and is adapted to receive the bar holder 54 against its forward surface 104 and to receive the springs 56 against portions of its rearward surface 106. The second spring plate 60 includes openings 108 for securing the springs 56 against the rearward surface 106. The second spring plate 60 also includes fingers 110 that extend from the rearward surface 106 for engagement with the through holes 102 in the first spring plate 58.

The bar holder 54 of this embodiment surrounds a bottom section 112 of the bar 52. The holder 54 has an elongate oval shape and includes flanges 114 that define a space 116 to receive the moisturizing bar 52. As shown in FIG. 6, the holder 54 of this embodiment includes two struts 118 that help to hold the bar 52 in place. The bar 52 may be molded into the holder 54 such that the two struts 118 extend through the bottom section 112. The holder 54 includes a suitable attachment mechanism for attachment to the first spring plate. In this embodiment, the holder 54 has tangs 120 (broadly, projections) that extend from a bottom surface 122 of the holder for engagement with complementary openings 124 in the second spring plate 60.

In this embodiment, the moisturizing bar 52 is adapted to deliver a metered amount of the moisturizer contained in the bar upon contact with skin, e.g., wet skin. For example, the metered amount is sufficient to form a lathering conditioner on the shaved skin. The metered amount also moisturizes the shaved skin. In one embodiment, the moisturizer bar is glycerin soap with about 1% fragrance. In other embodiments, the moisturizer bar may include other suitable compositions.

A method of one embodiment for shaving and simultaneously moisturizing the skin includes providing an electric shaver 10 such as that described above having a built-in solid moisturizer bar 52 adjacent a shaver head 16. The method also includes turning the shaver 10 on and then contacting the skin with the shaver head 16 of the electric shaver while simultaneously contacting the skin with the moisturizer bar 52. The skin may optionally be wetted prior to contacting the skin with the shaver head 16.

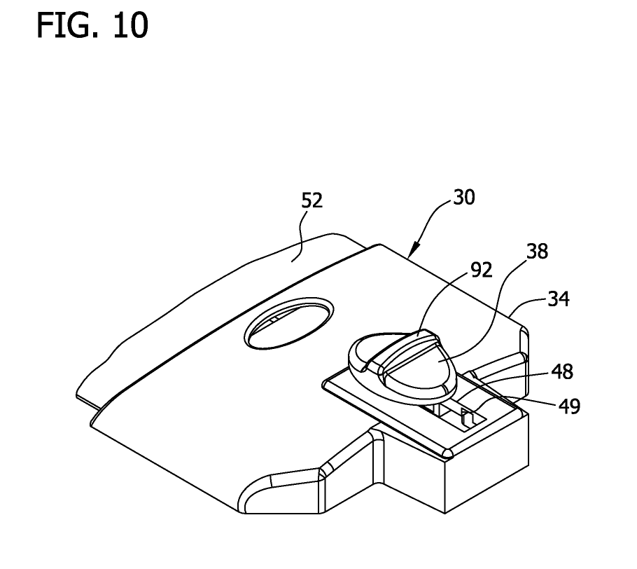

The method may also include adjusting the position of the moisturizer bar 52 to ensure simultaneous contact of the shaver head 16 and moisturizer bar. This may be necessary, for example, when the bar 52 has been used, but not completely exhausted so as to require replacement. In one embodiment, the button 38 on the receiver assembly 30 is pushed inward to disengage the button from the cut-out 49 of the slot 48 in the receiver housing 34, and then slid forward to the next cut-out 49. When the button is correctly engaged, the user will hear an audible ‘click’ or the like, and feel the button pop upward, so that the user knows the button 38 and slide 36 are properly positioned. FIG. 10 shows the button 38 and slide 36 in a forward position. This adjustment step may be performed a number of times over the useful life of the moisturizing bar 52 until the bar is exhausted.

When the bar 52 is exhausted, e.g., when the bar can no longer be adjusted to be in simultaneous contact with the skin during shaving, the bar may be replaced by the user. In this embodiment, replacement includes pulling the bar assembly 50 out of engagement with slide 36 of the receiver assembly 30, discarding the bar 52, then inserting a new bar into the bar assembly. The bar assembly 50 is then pushed into or seated in the housing 34 such that the slide 36 is engaged with the first spring plate 58 of the bar assembly. Depending on the position of the bar 52, adjustment may be required. The bar 52 can be adjusted by pushing the button 38 and sliding the slide 36 rearward. In an alternative embodiment, the bar 52 and the bar holder 54 may both be replaced, rather than just the bar. Other methods of replacement are also contemplated within the scope of this disclosure.

The moisturizing bar assembly may alternatively only include the bar and the holder, in which case the holder would be removably connectable to the second spring plate. In other words, the user, when replacing the bar, would replace only the bar and the holder, rather than the springs and spring plates.

The embodiments shown and described herein are merely examples, and many other configurations are contemplated within the scope of this disclosure. For example, the holder 54 for the moisturizer bar 52 may be omitted such that the bar is received directly against the second spring plate 60. The moisturizing bar 52 may also be differently positioned, such as between the shaving surfaces (e.g., the foil shavers 22).

Testing of embodiments of this disclosure revealed improved hydration of the skin. Using a REMINGTON® brand electric shaver including a moisturizer bar having glycerin soap with about 1% fragrance as described above and using a wet shave technique, hydration of the skin improved by 29% thirty minutes after use, by 24% 4 hours after use, and by 18% 24 hours after use. When using the same shaver and a dry shave technique, hydration improved by 16% after 30 minutes, 17% after 4 hours, but after 24 hours the difference was not statistically significant.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description and shown in the accompanying drawings shall be interpreted as illustrative and not in a limiting sense.

What is claimed is:

1. A shaver comprising:
a body;
a shaver head including at least one shaving surface;
at least one electrically powered blade in the body adjacent the shaver head;
a receiver assembly connected to the body adjacent the head;
a solid lubricant bar removably mounted in the receiver, the bar mounted for removal from the shaver.

2. The shaver of claim 1 wherein the moisturizing bar is adapted to deliver a metered amount of the moisturizer therein upon contact with wet skin.

3. The shaver of claim 1 wherein the moisturizing bar is adapted for replacement by the user.

4. The shaver of claim 1 wherein the shaving surface is one of a foil shaving surface or a rotary shaving surface.

5. The shaver of claim 1 wherein the bar includes a connector for connecting the bar to the receiver.

6. The shaver of claim 5 wherein the receiver includes a translatable portion and a stationary portion, the translatable portion connected to the bar for translation of the bar relative to the stationary portion and head.

7. The shaver of claim 1 wherein the receiver includes at least one spring for enabling movement of a connector for connecting the moisturizer bar to the shaver and the bar relative to the receiver.

8. The shaver of claim 1 wherein the receiver is permanently fixed to the head.

9. The shaver of claim 1 wherein the bar is mounted for movement relative to the receiver along at least one axis.

10. The shaver of claim 9 wherein the bar is mounted for movement relative to the receiver along at least two axes.

11. A moisturizer bar assembly adapted for connection to an electric shaver, the moisturizer bar assembly comprising:
a moisturizer bar adapted to deliver the moisturizer therein upon contact with skin; and
a connector for connecting the moisturizer bar to the electric shaver.

12. The assembly of claim 11 wherein the moisturizing bar is adapted to deliver a metered amount of the moisturizer therein upon contact with wet skin.

13. The assembly of claim 12 wherein the connector is mounted in the receiver to enable movement of the connector and the bar relative to the receiver along at least two axes.

14. The assembly of claim 12 wherein the connector includes projections for reception in a receiver of the electric shaver.

15. The assembly of claim 11 wherein the moisturizer bar comprises glycerin soap with about 1% fragrance.

16. A method of shaving and simultaneously moisturizing the skin, the method comprising:
providing an electric shaver having a built-in solid moisturizer bar adjacent a shaver head of the electric shaver;
activating the shaver; and
contacting the skin with the shaver head of the electric shaver while simultaneously contacting the skin with the moisturizer bar.

17. The method of claim 16 further comprising wetting the skin.

18. The method of claim 16 further comprising adjusting the position of the moisturizer bar to ensure simultaneous contact of the shaver head and moisturizer bar.

19. The method of claim 16 further comprising replacing the used moisturizer bar when the bar can no longer be adjusted to be in simultaneous contact.

20. The method of claim 19 wherein replacing the moisturizer bar includes removing the used moisturizer bar from a receiver of the shaver and inserting a new moisturizer bar in the receiver.
